(19) United States
(12) Patent Application Publication
(10) Pub. No.: US 2018/0090027 A1
(43) Pub. Date: Mar. 29, 2018

(54) INTERACTIVE TUTORIAL SUPPORT FOR INPUT OPTIONS AT COMPUTING DEVICES

(71) Applicant: Apple Inc., Cupertino, CA (US)

(72) Inventors: Matthew R. LEHRIAN, Pittsburgh, PA (US); Edward P. HOGAN, Pittsburgh, PA (US)

(21) Appl. No.: 15/275,221

(22) Filed: Sep. 23, 2016

(51) Int. Cl. G09B 19/00; G09B 5/12; G06F 17/24; G06F 9/44

(52) U.S. Cl. CPC G09B 19/0053; G09B 5/12; G06F 3/04842; G06F 9/4446; G06F 17/246

(57) ABSTRACT

The described embodiments set forth techniques for providing interactive tutorial support for input options at computing devices. According to some embodiments, an interactive tutorial manager of a given application can analyze input information against various available interactive tutorials to identify an appropriate interactive tutorial to be displayed. The interactive tutorial manager can then utilize tutorial logic associated with the interactive tutorial to display an interactive tutorial user interface (UI) at the computing device in accordance with the input information. In turn, and as subsequent inputs are received (in accordance with available inputs/operations associated with the interactive tutorial), the interactive tutorial UI can be updated to reflect the subsequent inputs. Ultimately, when the input requirements for a particular operation are satisfied, the interactive tutorial UI can be disabled/hidden within the application, and the operation can be carried out as appropriate.

### FIELD

The described embodiments set forth techniques for providing interactive tutorial support for input options at computing devices. In particular, the input options can be tied to available operations that can be performed at the computing device, thereby exposing users to rich features without overwhelming them.

### BACKGROUND

Advanced input technologies—such as touch-based inputs, voice-based inputs, etc.—have become a primary means for users to interact with modern computing devices (e.g., smart phones, tablets, wearables, laptops, etc.). For example, a given computing device can include hardware components that enable a user's physical touch to be detected on a surface (e.g., a screen, a touch pad, etc.) of the computing device. In turn, the physical touch is translated into input events that are understood by software executing on the computing device (e.g., an operating system, a daemon, a user application, etc.), whereupon the software can immediately respond to the input events. Consider, for example, a basic single-finger tap on a particular area of a screen, which has evolved as a replacement for a left mouse-click. Notably, the single-finger tap beneficially eliminates the need for a user to first migrate a cursor to the area of the screen prior to left-clicking the mouse, which can be time-consuming and tedious. As a result, the user's experience can be considerably enhanced given the modern input methods feel more natural and intuitive.

The substantial advancements made in hardware and software over time have contributed to the overall effectiveness of advanced input technologies. For example, multi-touch gestures have become commonplace and can enable users to perform a variety of useful operations while maintaining the same natural and intuitive feel associated with basic touch inputs. As a result, mouse-based inputs are being phased out in many areas, which has established a generalized expectation among users for all software applications—both old and new—to have UIs that function naturally with touch-based input. However, as is well-known, many software applications—e.g., spreadsheet applications, presentation applications, etc.—have UIs that are specifically tailored to mouse-based inputs, and it is undesirable to drastically transform these UIs just to support touch input. Consequently, software developers are faced with the undesirable situation where they must choose between retaining a well-understood/received mouse-based UI layout (and disregarding touch-based input), or migrating to a new/unfamiliar touch-based UI layout (and providing touch-based input). Moreover, the available inputs associated with modern input methods are increasing in quantity and complexity over time, which can be daunting for users when they are faced with input options that are not well-understood.

### SUMMARY

To cure the foregoing deficiencies, the described embodiments set forth techniques for providing interactive tutorial support for input options at computing devices. According to some embodiments, an interactive tutorial manager of a given application can analyze input information against various available interactive tutorials to identify an appropriate interactive tutorial to be displayed. The interactive tutorial manager can then utilize tutorial logic associated with the interactive tutorial to display an interactive tutorial user interface (UI) at the computing device in accordance with the input information. In turn, and as subsequent inputs are received (in accordance with available inputs/operations associated with the interactive tutorial), the interactive tutorial UI can be updated to reflect the subsequent inputs. Ultimately, when the input requirements for a particular operation are satisfied, the interactive tutorial UI can be disabled/hidden within the application, and the operation can be carried out as appropriate.

One embodiment sets forth a technique for providing an interactive tutorial UI at a computing device. In particular, the method can be carried out at the computing device, and includes the steps of (1) receiving a selection of a UI element included in a UI displayed at the computing device, (2) displaying the interactive tutorial UI in response to the selection, where the interactive tutorial UI indicates available input types (e.g., gestures)/operations (e.g., application functions) based on (i) a type of the selection, and (ii) a type of the UI element, (3) identifying an input type among the available input types based on a continuous/sequential input received in association with the selection, and (4) hiding the interactive tutorial UI in response to (i) a completion of the operation, or (ii) a cessation of the continuous/sequential input.

Other embodiments include at least one non-transitory computer readable medium configured to store instructions that, when executed by at least one processor included in a computing device, cause the computing device to implement any of the techniques set forth herein. Further embodiments include a computing device that includes at least one memory and at least one processor that, in conjunction, enable the computing device to implement the various techniques set forth herein.

This Summary is provided merely for purposes of summarizing some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

Other aspects and advantages of the embodiments described herein will become apparent from the following detailed description taken in conjunction with the accompanying drawings which illustrate, by way of example, the principles of the described embodiments

### BRIEF DESCRIPTION OF THE DRAWINGS

The included drawings are for illustrative purposes and serve only to provide examples of possible structures and arrangements for the disclosed inventive apparatuses and methods for their application to computing devices. These drawings in no way limit any changes in form and detail that can be made to the embodiments by one skilled in the art without departing from the spirit and scope of the embodiments. The embodiments will be readily understood by the following detailed description in conjunction with the accompanying drawings, wherein like reference numerals designate like structural elements.

FIGS. 1A-1B illustrate block diagrams of different components of a computing device configured to implement the various techniques described herein, according to some embodiments.

FIGS. 2A-2D illustrate conceptual diagrams of a sequence involving an interactive tutorial interface being displayed in conjunction with column operations performed within a spreadsheet application, according to some embodiments.

FIGS. 3A-3D illustrate conceptual diagrams of a sequence involving an interactive tutorial interface being displayed in conjunction with row operations performed within a spreadsheet application, according to some embodiments.

FIG. 4 illustrates a method for displaying an interactive tutorial user interface (UI) at the computing device of FIGS. 1A-1B in accordance with received inputs, according to some embodiments.

FIG. 5 illustrates a block diagram of a computing device that can represent the components of a computing device or any other suitable device or component for realizing any of the methods, systems, apparatus, and embodiments described herein.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The embodiments described herein set forth techniques for providing interactive tutorial support for input options at computing devices. According to some embodiments, an input manager and one or more applications can execute at a computing device (e.g., by way of an operating system configured to execute on the computing device). According to some embodiments, the input manager can represent a daemon of the operating system that serves as a translation layer between the inputs made to the computing device and the applications. For example, the input manager can be configured to receive input information from an input interface of the computing device, translate the input information into a defined input event (e.g., a touch-and-hold event, a tap event, a swipe event, etc.), and then provide the input event to the application that is active at the computing device. In turn, the application can appropriately process the input event and display an appropriate interactive tutorial in accordance with the input event, where the interactive tutorial indicates a number of operations that can be carried out, as well as corresponding input events for triggering the operations. In turn, as subsequent input events (that match the input events associated with the interactive tutorial) are received, the interactive tutorial UI can be updated to reflect a progress of the completion of the subsequent input events for triggering the corresponding operation(s). Ultimately, when the input events corresponding to a particular operation are satisfied, the interactive tutorial UI can be disabled/hidden within the application, and the operation can be carried out as appropriate.

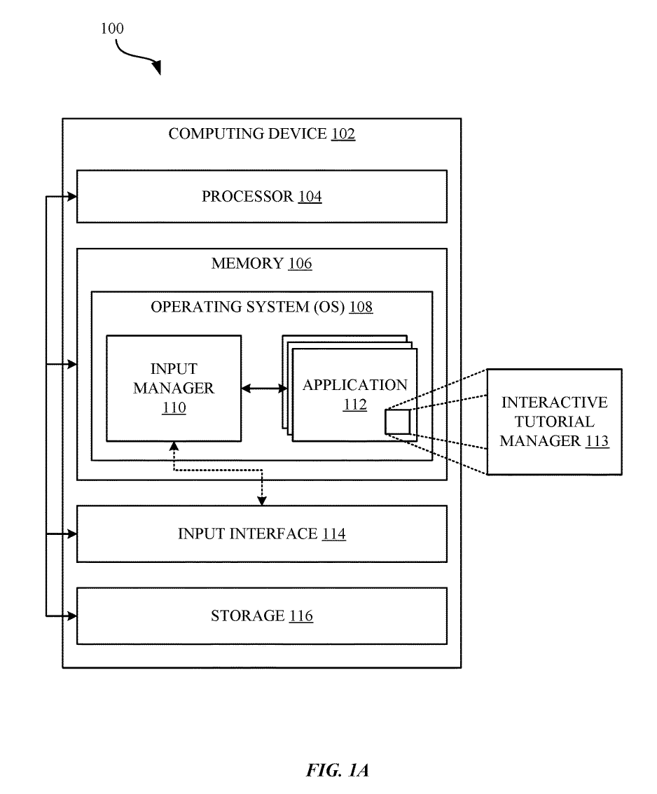

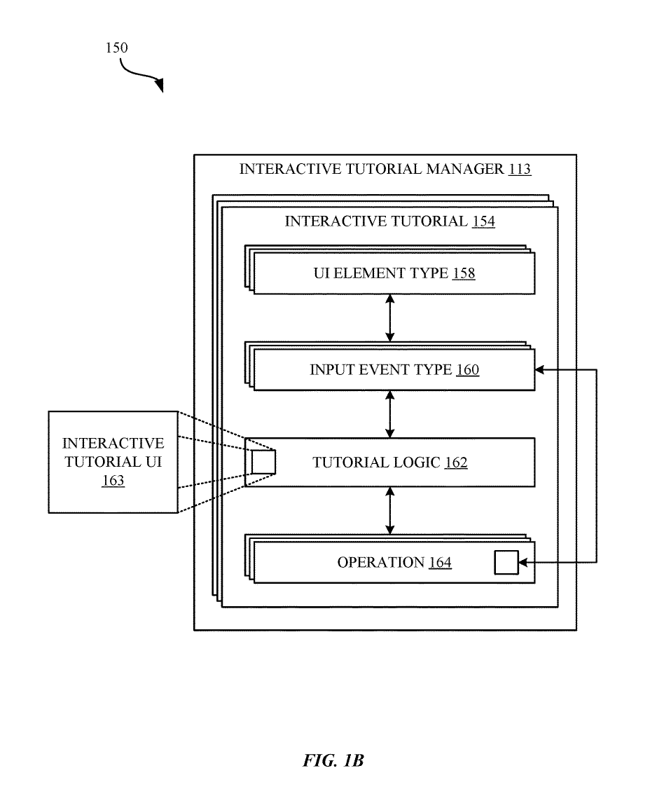

A more detailed discussion of these techniques is set forth below and described in conjunction with FIGS. 1-5, which illustrate detailed diagrams of systems and methods that can be used to implement these techniques.

FIG. 1A illustrates a block diagram 100 of different components of a computing device 102 that is configured to implement the various techniques described herein, according to some embodiments. More specifically, FIG. 1A illustrates a high-level overview of the computing device 102, which, as shown, can include at least one processor 104, at least one memory 106, at least one input interface 114, and at least one storage 116. According to some embodiments, the storage 116 can represent a storage device that is accessible to the computing device 102, e.g., a hard disk drive, a solid state drive, a mass storage device, a remote storage device, and the like. In some examples, the storage 116 can represent a storage that is accessible to the computing device 102 via a local area network (LAN), a personal area network (PAN), and the like.

According to some embodiments, the processor 104 can be configured to work in conjunction with the memory 106 and the storage 116 to enable the computing device 102 to operate in accordance with this disclosure. For example, the processor 104 can be configured to load/execute an operating system 108 that enables a variety of processes to execute on the computing device 102, e.g., OS daemons, native OS applications, user applications, and the like. For example, as shown in FIG. 1A, the operating system 108 can include an input manager 110 and one or more applications 112. According to some embodiments, the input manager 110 can represent a daemon of the operating system 108 that serves as a translation layer between the inputs made to the computing device 102 and the applications 112. For example, the input manager 110 can be configured to receive input information from the input interface 114, translate the input information into a defined input event (e.g., a touch-and-hold event, a tap event, a swipe event, etc.), and then provide the input event to an application 112 (e.g., the application 112 that is active at the computing device 102). In turn, the application 112 can process the input event and display an appropriate interactive tutorial in accordance with an interactive tutorial manager 113 managed by the application 112, the details of which are described below in greater detail in conjunction with FIG. 1B.

According to some embodiments, the input interface 114 can represent at least one component of the computing device 102 that is configured to receive and process inputs at the computing device 102. For example, the input interface 114 can be configured to receive mouse-based inputs, keyboard-based inputs, joystick-based inputs, touch-based inputs, motion-based inputs, audio-based inputs, image/camera-based inputs, and so on, and provide the inputs to the input manager 110/applications 112/interactive tutorial managers 113 for subsequent processing. According to some embodiments, the input interface 114 can be capable of pre-processing the input information prior to providing the input information to the input manager 110/applications 112/interactive tutorial managers 113 for processing. For example, when receiving motion-based inputs, the input interface 114 can be configured to filter out extraneous input information (e.g., noise) in order to simplify the responsibilities of the input manager 110 and to increase overall processing accuracy. Although not illustrated in FIG. 1A, the computing device 102 can include communications interfaces that enable the input interface 114 to receive the aforementioned input types from various input devices, e.g., Universal Serial Bus (USB) interfaces, Bluetooth interfaces, Near Field Communication (NFC) interfaces, WiFi interfaces, and so on. It is also noted that the various input devices—e.g., mice, keyboards, joysticks, wands, touchpads/touch screens, cameras, microphones, etc.—can be external to or internal to the computing device 102. In this manner, the computing device 102 can be capable of displaying interactive tutorials in conjunction with receiving and processing virtually any form of input made to the computing device 102.

As previously noted herein, the input manager 110, the applications 112, and the interactive tutorial manager 113 can be configured to work together when providing the interactive tutorials described herein. FIG. 1B illustrates a block diagram 150 of a hierarchical breakdown of different components that can be included in the interactive tutorial manager 113 of an application 112, according to some embodiments. As shown in FIG. 1B, the interactive tutorial manager 113 can manage a number of interactive tutorials 154, where each interactive tutorial 154 references: different user interface (UI) element types 158, different input event types 160, tutorial logic 162, and operations 164. According to some embodiments, and as described in greater detail below, the interactive tutorial manager 113 can be configured to analyze the UI element types 158, the input event types 160, and/or other information when inputs are made to the application 112 to identify an appropriate interactive tutorial 154 to display at the computing device 102.

According to some embodiments, the UI element types 158 can represent different kinds of UI elements that are associated with the interactive tutorial 154. For example, when the interactive tutorial manager 113 is associated with an application 112 that implements electronic spreadsheets, the UI element types 158 for a given interactive tutorial 154 can refer to row header UI elements. Similarly, the UI element types 158 for another interactive tutorial 154 can refer to column header UI elements. In this manner, when a selection of a row header UI element or a column header UI element is made within the application 112, the interactive tutorial manager 113 can respond by analyzing the UI element types 158 of the different interactive tutorials 154 to identify the interactive tutorial 154 that best-corresponds to the selection.

Additionally, and as previously mentioned above, each interactive tutorial 154 can also include input event types 160 that enable the interactive tutorial manager 113 to further-narrow the interactive tutorial 154 selection process when responding to input events received by the application 112. For example, continuing with the spreadsheet example described above, when the selection indicates a touch-and-hold event at a column header UI element, the interactive tutorial manager 113 can respond by analyzing the input events types 160 of the different interactive tutorials 154 to further identify the interactive tutorial 154 that best-corresponds to the selection.

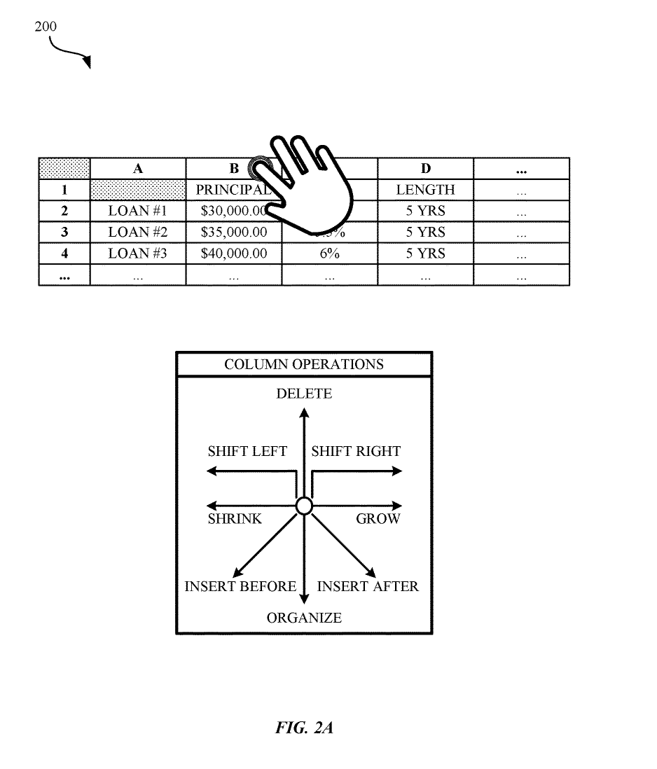

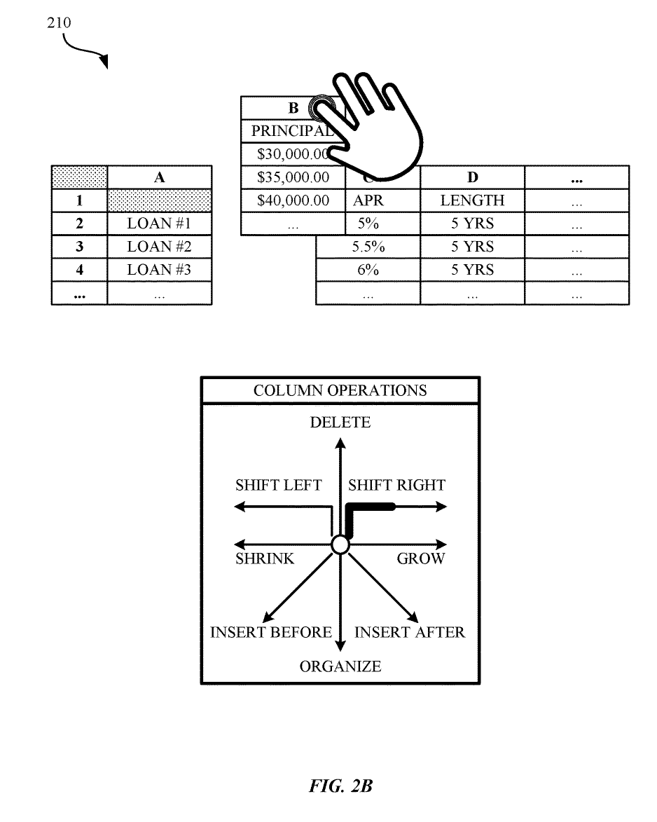

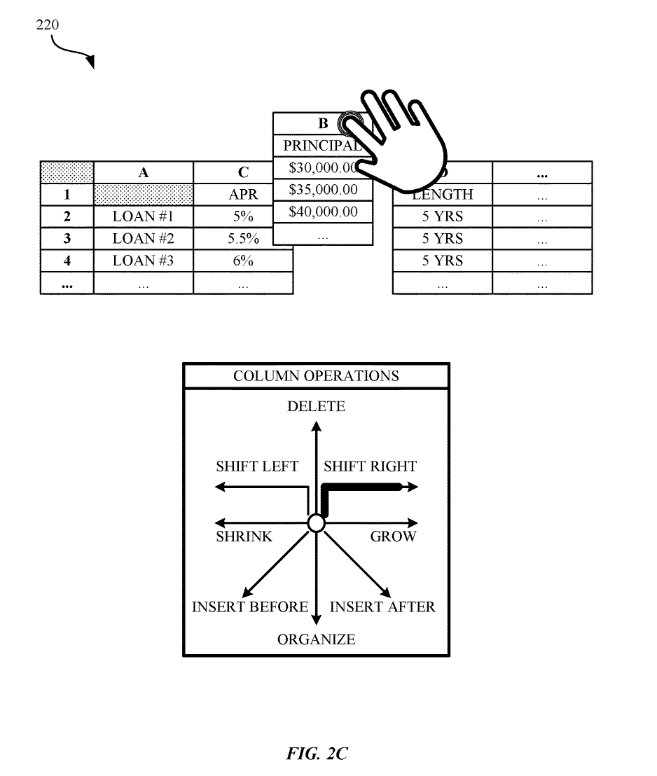

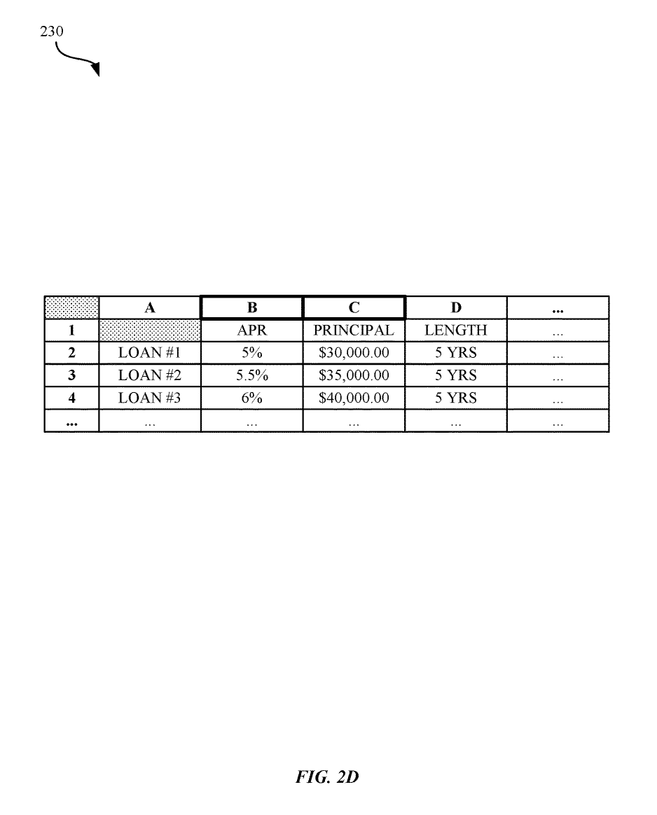

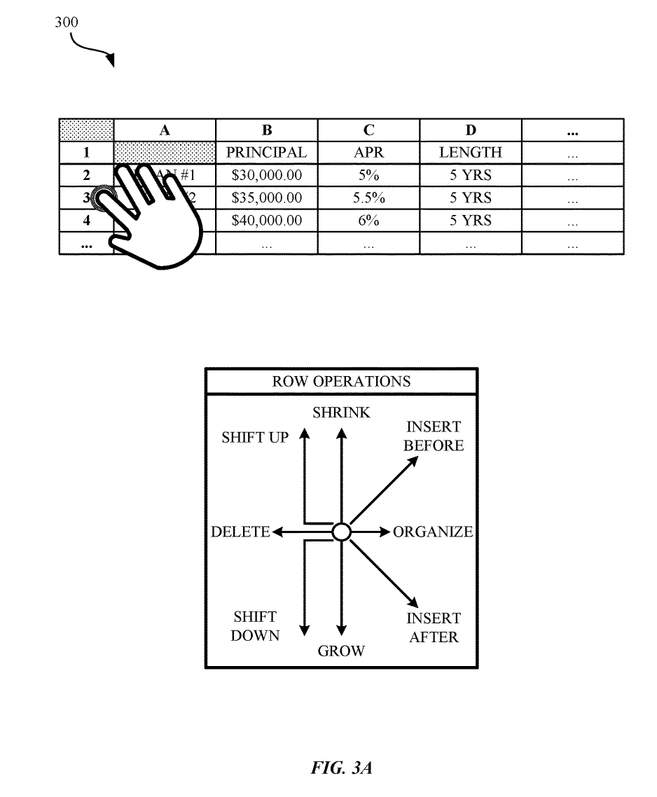

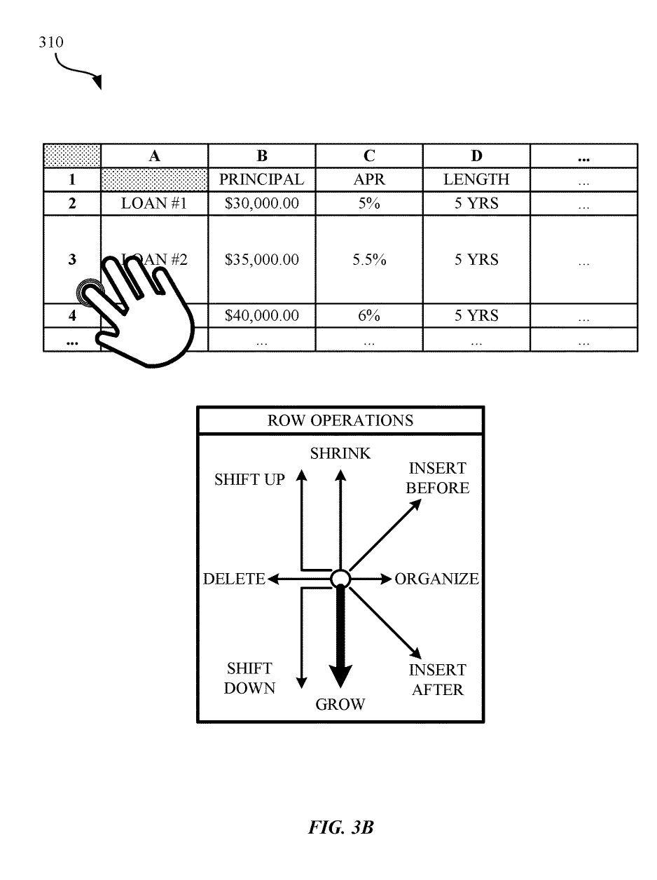

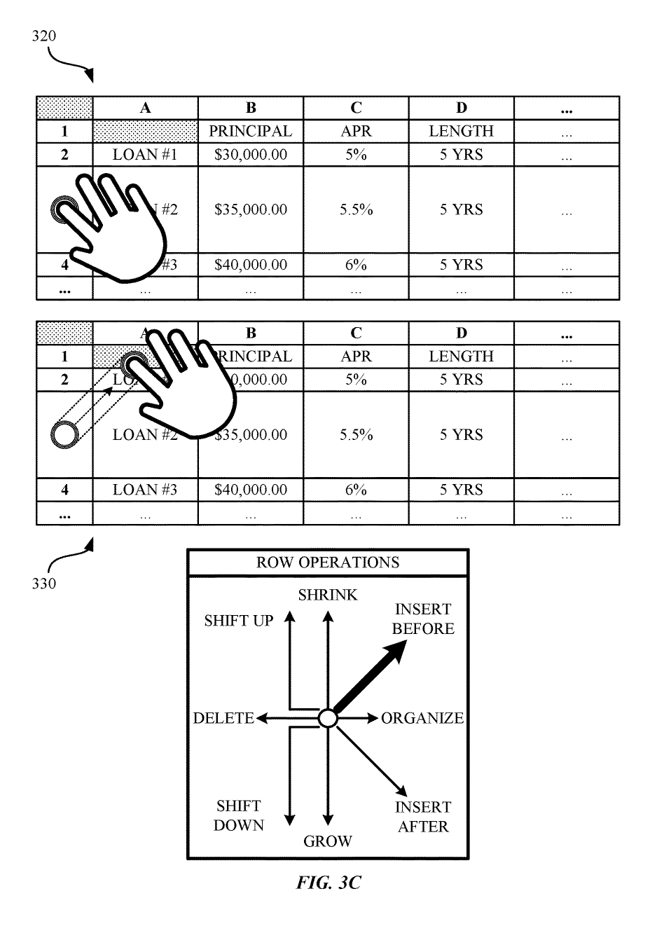

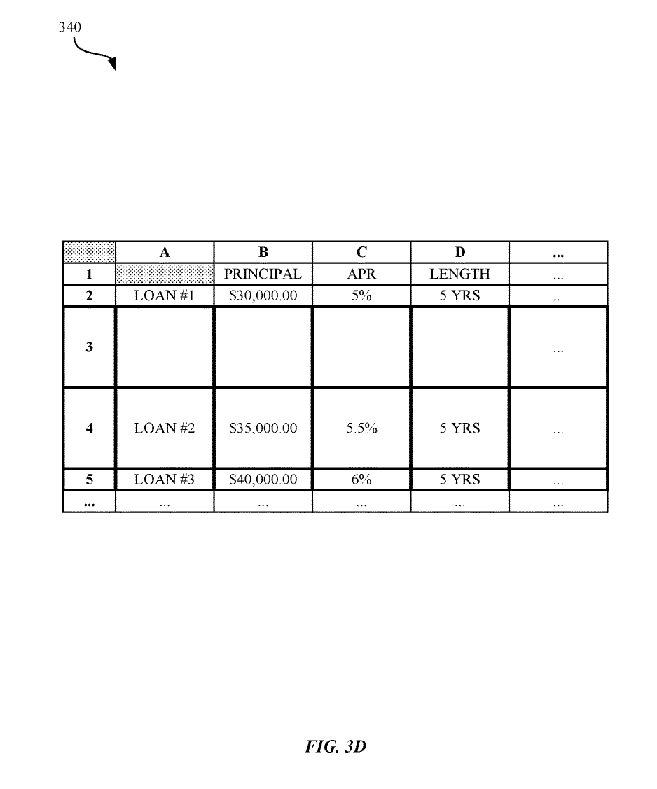

Accordingly, when the interactive tutorial manager 113 identifies an appropriate interactive tutorial 154, the tutorial logic 162 can be utilized for displaying an interactive tutorial UI 163 at the computing device 102. According to some embodiments, the tutorial logic 162 can include the logic/information for appropriately displaying the interactive tutorial UI 163. For example, continuing with the spreadsheet example described above, when a selection is associated with a touch-and-hold event of a column header UI element, an appropriate interactive tutorial 154 is identified, and the associated interactive tutorial UI 163 can be configured to display a list of available operations 164 that can be performed in accordance with the selection. According to some embodiments, and as illustrated in FIG. 1B, each operation 164 can be associated with at least one input event type 160 that, when performed, causes the operation 164 to be carried out within the scope of the application 112. For example, continuing with the spreadsheet example described above, when the selection is associated with a touch-and-hold event of a column header UI element, the interactive tutorial UI 163 can indicate that a “drag-up” input event will cause the corresponding column to be deleted from the active spreadsheet within the application 112. In this example, when the drag-up event occurs, the tutorial logic 162 can identify the operation 164 that corresponds to the drag-up event, and then cause the operation 164 (i.e., deleting the corresponding column) to be carried out within the application 112. Specific examples of the interactive tutorials 154 are described below in conjunction with FIGS. 2A-2D and FIGS. 3A-3D.

It is noted that any number of interactive tutorials 154, as well as any combination of UI element types 158/input event types 160 can be implemented within the interactive tutorial manager 113 to enable an application 112 to establish a rich collection of interactive tutorials to improve the user's overall experience. In some cases, a collection of interactive tutorials 154 with substantially overlapping UI element types 158 and input event types 160 can be managed by an interactive tutorial manager 113. To handle such situations, the interactive tutorial manager 113 can be configured to analyze the interactive tutorials 154 in accordance with selection information—e.g., the type of UI element selected, the nature/type of the selection, etc.—and select the interactive tutorial 154 that is the strongest candidate. Moreover, it is noted that the interactive tutorial manager 113 is not limited only to analyzing UI element types 158 and input event types 160 (e.g., when attempting to identify a corresponding interactive tutorial 154), and that any form of input information can be utilized by the interactive tutorial manager 113 when implementing the techniques described herein.

Additionally, it is noted that the input types discussed herein are merely exemplary and do not represent an exhaustive list of input types that are compatible with the embodiments described herein. On the contrary, the embodiments described herein can function with any type of input, e.g., mouse-based inputs (e.g., mouse paths/click sequences), keyboard-based inputs (e.g., keystroke sequences), joystick-based inputs (e.g., input paths), touch-based inputs (e.g., input paths/gestures), motion-based inputs (e.g., input paths/gestures), audio-based inputs (e.g., voice commands), image/camera-based inputs (e.g., visual commands), and so on. In other words, an interactive tutorial can be displayed in conjunction with any form of input event, where 1) the interactive tutorial displays available operations based on information associated with the input event (e.g., a type of the input event, a location of the input event, etc.), information associated with the selected UI element (e.g., a type of the selected UI element, a location of the selected UI element, etc.), and/or other information, 2) the interactive tutorial is updated in accordance with continuous/sequential input events received, and 3) the interactive tutorial is disabled/hidden when the continuous/sequential input events cease or when the operation is completed.

Accordingly, FIGS. 1A-1B set forth an overview of different components/entities that can be included in the computing device 102 to enable the embodiments described herein to be properly implemented. Examples are described herein with respect to spreadsheets but tutorials can be presented for any type of application such as (but not limited to) a web browser, word processor, presentation program, electronic mail program, and so on. In summary, and as described in greater detail below in conjunction with FIGS. 2A-2D and FIGS. 3A-3D, an interactive tutorial manager 113 of a given application 112 can analyze input information (e.g., an input event type 160) received from the input manager 110) against various interactive tutorials 154 to identify an appropriate interactive tutorial 154. The interactive tutorial manager 113 can then utilize the tutorial logic 162 of the interactive tutorial 154 to display an interactive tutorial UI 163 at the computing device 102 in accordance with the input information. In turn, as subsequent input events are received (as a user works toward causing one or more operations 164 to be executed), the interactive tutorial UI 163 can be updated to reflect the subsequent input events. Ultimately, when the input requirements for a particular operation 164 are satisfied, the interactive tutorial UI 163 can be disabled/hidden within the application 112, and the operation 164 can be carried out as appropriate.

Additionally, it is noted that while the embodiments described herein involve techniques that are implemented by interactive tutorial managers 113 that execute on the computing device 102 under the control of the operating system 102/application 112, the embodiments are not so limited. On the contrary, the techniques can be implemented on one or more computing devices with which the computing device 102 is configured to communicate. For example, the computing device 102 can be configured to provide, to a server device, input events/other corresponding information (e.g., information associated with the active application 112 executing on the computing device 102, information associated with the UI element selected within the active application 112, etc.). In turn, the server device can respond with information that enables an interactive tutorial UI 163 to be displayed at the computing device 102. In this manner, the processing overhead associated with the techniques described herein can be shared by or offloaded to the server device.

Additionally, it is noted that the computing device 102 and/or server device can be configured to implement machine-learning techniques to dynamically modify the layout/contents of different interactive tutorials 154 to ensure maximum operating efficiency. For example, the computing device 102 and/or server device can be configured to monitor/process feedback received as users navigate applications 112 using the interactive tutorial UIs 163 and make adjustments where necessary to improve overall usability. For example, the computing device 102 and/or server device can determine that a particular operation 164 for a given application 112 is most commonly accessed by users, and, in response, a corresponding interactive tutorial UI 163 can be updated to associate the particular operation 164 with an input event type 160 that is most easily carried out by users (e.g., a simple gesture input). In another example, the computing device 102 and/or server device can determine that users often fail when attempting to provide a particular input event type 160 (e.g., a complicated gesture) to cause a particular operation 164 to be carried out. In response, the computing device 102 and/or server device can update the corresponding interactive tutorial UI 163 and associate the particular operation 164 with a different input event type 160 that is well-understood by users and easier to execute. This approach can beneficially promote a more natural and intuitive operating environment and can dramatically improve the user's overall experience.

FIGS. 2A-2D illustrate conceptual diagrams of a sequence involving an interactive tutorial UI 163 being displayed in conjunction with column operations performed within a spreadsheet application 112, according to some embodiments. As shown in FIG. 2A, a step 200 can involve the interactive tutorial manager 113 (associated with the application 112) receiving a selection of a UI element within the spreadsheet application 112. As shown in FIG. 2A, the selection is associated with a column header UI element of the active spreadsheet within the spreadsheet application 112. In turn, an in accordance with the techniques described herein, the interactive tutorial manager 113 analyzes the selection against available interactive tutorials 154 to identify any interactive tutorials 154 that reference UI element types 158 that correspond to the column header UI element. Moreover, the selection can indicate a type of input event 160 (e.g., a touch-and-hold), and the interactive tutorial manager 113 can identify any interactive tutorials 154 that reference input event types 160 that correspond to the input event 160 indicated in the selection. In this manner, the interactive tutorial manager 113 can effectively identify an interactive tutorial 154 that best-corresponds to the selection, and, in turn, utilize the tutorial logic 162 to display the appropriate interactive tutorial UI 163.

As shown in FIG. 2A, the interactive tutorial UI 163 can display a list of available inputs/operations based on the input event types 160 and operations 164 that are associated with the interactive tutorial 154 (and are available for column-based operations within the application 112). For example, the interactive tutorial UI 163 illustrated in FIG. 2A includes eight different input event types 160—illustrated as touch-based gesture paths—where each input event type 160 is associated with a different operation 164 (e.g., shift left, delete, shift right, etc.). In this manner, a user of the application 112 is presented with a clear understanding of the inputs that can be made (i.e., subsequent to their initial selection of the column header UI element) to cause the application 112 to carry out different operations 164. According to some embodiments, the interactive tutorial UI 163 can be partially transparent in order to minimize the obstruction of any underlying UI of the application 112 that should remain visible to the user.

Turning now to FIG. 2B, step 210 illustrates a process that involves the interactive tutorial manager 113 receiving a continuous/sequential input (in connection with the initial selection). In particular, and as illustrated in FIG. 2B, the continuous/sequential input coincides with the input event type 160 gesture that corresponds to the “shift right” operation 164. According to some embodiments, the interactive tutorial manager 113—in conjunction with the tutorial logic 162 of the interactive tutorial 154—can be configured to update the interactive tutorial UI 163 to indicate that the continuous/sequential input is identified and corresponds to the “shift right” operation 164. For example, as shown in FIG. 2B, the gesture path associated with the “shift right” operation 164 is highlighted to indicate a status of the completion of the gesture path that will ultimately cause the application 112 to carry out the “shift right” operation 164. For example, step 220 of FIG. 2C indicates a continuation of the process of step 210 of FIG. 2B, where the interactive tutorial UI 163 is updated to indicate that that the gesture path associated with the “shift right” operation 164 is nearing completion.

Turning now to FIG. 2D, step 230 indicates the result of a completion of the gesture path associated with the “shift right” operation 164. As shown in FIG. 2D, the interactive tutorial UI 163 can be disabled/hidden within the application 112. It is noted that the interactive tutorial manager 113 can also be configured to disable/hide the interactive tutorial UI 163 in response to a cessation of the continuous/sequential input, e.g., when a user fails to complete any of the available gesture paths associated with the input event types 160. In any event, when the gesture path associated with the “shift right” operation 164 is completed, the application 112 can be configured to carry out the necessary actions, e.g., causing the columns to be appropriately shifted within the spreadsheet, as reflected in FIG. 2D.

Accordingly, the techniques described herein enable users to be conveniently informed of/guided through the available operations 164 when they perform an initial selection of a UI element within an application 112, which can substantially enhance their overall user experience. Moreover, the interactive tutorial manager 113 can be configured to enable users to customize the interactive tutorial UIs 163 in any possible manner in order to support their preferences/desired options. For example, an interactive tutorial UI 163 can be configured to include a button that, when selected, places the interactive tutorial UI 163 into an edit mode that enables the user to select from different available input event types 160, different available operations 164, and so on. Moreover, the interactive tutorial manager 113 can be configured to enable the user to create their own input event types 160 (e.g., gesture paths) and select/create operations 164 to further enhance the level of customization that is available. Additionally, the interactive tutorial manager 113 can implement a wizard-type interface that enables users to sequentially/logically associated input event types 160 with different operations 164. For example, the interactive tutorial manager 113 can direct a user to select available one or more operations 164 (or provide custom operations 164), and also select one or more associated input event types 160 (or provide custom event types 160), thereby enabling the user to establish a customized interactive tutorial UI 163/underlying functionality that operates in accordance with the user's preferences.

Again, it is noted that the touch-based inputs/operations discussed herein are merely exemplary and do not in any way limit the scope of the embodiments described herein. On the contrary, any form of input can be utilized/customized, e.g., mouse-based inputs (e.g., mouse paths/click sequences, etc.), keyboard-based inputs (e.g., keystroke sequences, etc.), joystick-based inputs (e.g., input paths, etc.), touch-based inputs (e.g., input paths/gestures, etc.), motion-based inputs (e.g., input paths/gestures, etc.), audio-based inputs (e.g., voice commands, etc.), image/camera-based inputs (e.g., visual commands, etc.), and so on.

FIGS. 3A-3D illustrate conceptual diagrams of a sequence involving an interactive tutorial UI 163 being displayed in conjunction with row operations performed within a spreadsheet application 112, according to some embodiments. As shown in FIG. 3A, a step 300 can involve the interactive tutorial manager 113 receiving a selection of a UI element within the spreadsheet application 112. More specifically, and as shown in FIG. 3A, the selection is associated with a row header UI element of the active spreadsheet within the spreadsheet application 112. In response, the interactive tutorial manager 113 analyzes the selection against available interactive tutorials 154 to identify any interactive tutorials 154 that reference UI element types 158 that correspond to the row header UI element. Moreover, the selection can indicate an input event type 160 (e.g., a touch-and-hold), and the interactive tutorial manager 113 can identify any interactive tutorials 154 that reference input event types 160 that correspond to the type of input indicated in the selection. In this manner, the interactive tutorial manager 113 can effectively identify an interactive tutorial 154 that best-corresponds to the selection, and, in turn, utilize the tutorial logic 162 to display the appropriate interactive tutorial UI 163.

As shown in FIG. 3A, the interactive tutorial UI 163 can display a list of available inputs/operations based on the input event types 160 and operations 164 that are associated with the interactive tutorial 154 and are available for row-based operations. For example, the interactive tutorial UI 163 illustrated in FIG. 3A includes eight different input event types 160—illustrated as touch-based gesture paths—where each input event type 160 is associated with a different operation 164 (e.g., shift down, grow, insert after, etc.). In this manner, a user of the application 112 is presented with a clear understanding of the inputs that can be made (subsequent to their initial selection of the row header UI element) to cause the application 112 to carry out different operations 164.

Turning now to FIG. 3B, step 310 illustrates a process that involves the interactive tutorial manager 113 receiving a continuous/sequential input (in connection with the initial selection). In particular, and as illustrated in FIG. 3B, the continuous/sequential input coincides with the input event type 160 gesture that corresponds to the “grow” operation 164. According to some embodiments, the interactive tutorial manager 113—in conjunction with the tutorial logic 162 of the interactive tutorial 154—can be configured to update the interactive tutorial UI 163 to indicate that the continuous/sequential input is identified and corresponds to the “grow” operation 164. For example, as shown in FIG. 2B, the gesture path associated with the “grow” operation 164 is highlighted to indicate a status of the completion of the gesture path that will ultimately cause the application 112 to carry out the “grow” operation 164.

Turning now to FIG. 3C, step 320 illustrates a process that involves the interactive tutorial manager 113 receiving another initial selection of a row header UI element, and subsequently receiving a continuous/sequential input (in connection with the initial selection). In particular, and as illustrated in FIG. 3C, the continuous/sequential input coincides with the input event type 160 gesture that corresponds to the “insert before” operation 164. As previously described herein, the interactive tutorial manager 113—in conjunction with the tutorial logic 162 of the interactive tutorial 154—can be configured to update the interactive tutorial UI 163 to indicate that the continuous/sequential input is identified and corresponds to the “insert before” operation 164. For example, and as shown at step 330 of FIG. 3C, the gesture path associated with the “insert before” operation 164 is highlighted to indicate a status of the completion of the gesture path that ultimately causes the application 112 to carry out the “insert before” operation 164, which is reflected at step 340 illustrated in FIG. 3D.

Turning now to FIG. 3D, step 340 indicates the result of a completion of the gesture path associated with the “insert before” operation 164, where a new row has been added before the row selected at step 320 in FIG. 3C. As shown in FIG. 3D, the interactive tutorial UI 163 can be disabled/hidden within the application 112. Again, it is noted that the interactive tutorial manager 113 can be configured to hide/disable the interactive tutorial UI 163 in response to a cessation of the continuous/sequential input, e.g., when the user fails to complete any of the available gesture paths associated with the input event types 160.

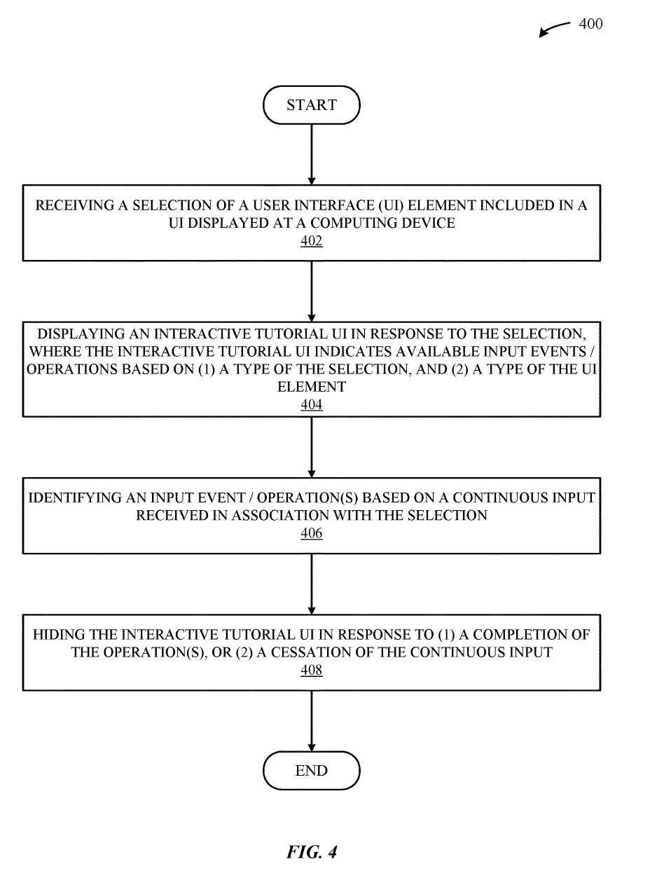

FIG. 4 illustrates a method 400 for providing an interactive tutorial UI 163 at the computing device 102 of FIGS. 1A-1B, according to some embodiments. As shown in FIG. 4, the method 400 begins at step 402, where interactive tutorial manager 113 receives a selection of a UI element included in a UI (e.g., of an application 112) displayed at the computing device 102. Although not illustrated in FIG. 4, step 402 can involve the interactive tutorial manager 113 identifying an appropriate interactive tutorial 154 based on information associated with the selection of the UI element (e.g., the UI element type 158, a location of the UI element, a state of the UI element, etc.), information associated with the selection (e.g., an input event type 160 associated with the selection, a location of the selection, etc.), and any other information that enables the interactive tutorial manager 113 to select an appropriate interactive tutorial 154.

At step 404, the interactive tutorial manager 113 displays an interactive tutorial UI 163 in response to the selection received at step 402, where the interactive tutorial UI 163 indicates the available input event types 160 (e.g., gestures)/operations 164 associated with the interactive tutorial 154. At step 406, interactive tutorial manager 113 identifies an input event type 160/operation(s) 164 based on a continuous/sequential input received in association with the selection made at step 402. Finally, at step 408, interactive tutorial manager 113 hides the interactive tutorial UI 163 in response to (1) a completion of the operation(s) 164, or (2) a cessation of the continuous/sequential input, as previously described herein in conjunction with FIGS. 2A-2D and FIGS. 3A-3D.

In sum, the described embodiments set forth techniques for providing interactive tutorial support for input options at computing devices. An interactive tutorial manager of a given application can analyze input information against various available interactive tutorials to identify an appropriate interactive tutorial. The interactive tutorial manager can then utilize tutorial logic associated with the interactive tutorial to display an interactive tutorial UI at the computing device in accordance with the input information. In turn, as continuous/subsequent inputs are received (in accordance with available inputs/operations associated with the interactive tutorial), the interactive tutorial UI can be updated to reflect the subsequent inputs. Ultimately, when the input requirements for a particular operation are satisfied, the interactive tutorial UI can be disabled/hidden within the application, and the operation can be carried out as appropriate.

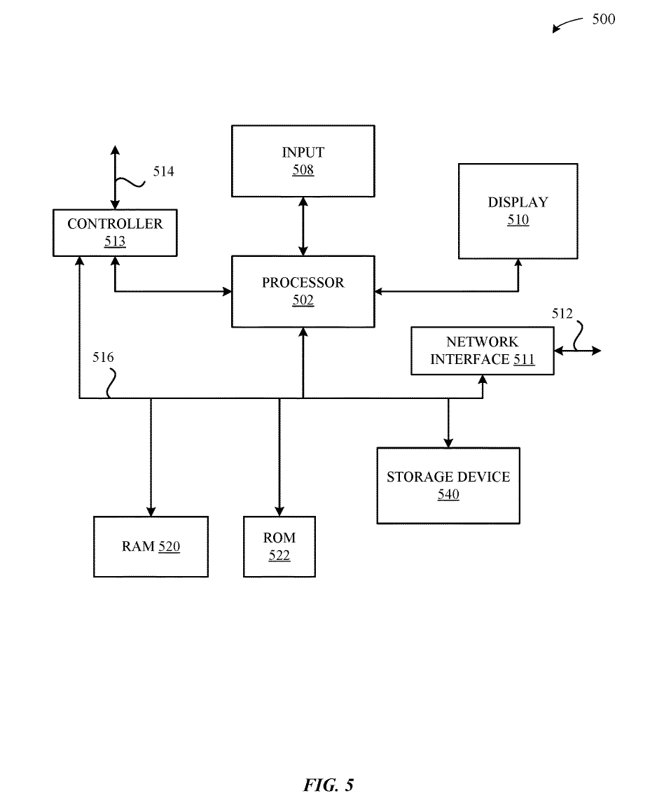

FIG. 5 illustrates a detailed view of a computing device 500 that can be used to implement the various techniques described herein, according to some embodiments. In particular, the detailed view illustrates various components that can be included in the computing device 102 illustrated in FIGS. 1A-1B. As shown in FIG. 5, the computing device 500 can include a processor 502 that represents a microprocessor or controller 513 for controlling the overall operation of computing device 500. The computing device 500 can also include a user input device 508 that allows a user of the computing device 500 to interact with the computing device 500. Still further, the computing device 500 can include a display 510 (screen display) that can be controlled by the processor 502 to display information to the user. A data bus 516 can facilitate data transfer between the storage device 540, the processor 502, and the controller 513. The controller 513 can be used to interface with and control different equipment through an equipment control bus 514. The computing device 500 can also include a network/bus interface 511 that couples to a data link 512. In the case of a wireless connection, the network/bus interface 511 can include a wireless transceiver.

The computing device 500 also include a storage device 540, which can comprise a single disk or multiple disks (e.g., hard drives), and includes a storage management module that manages one or more partitions within the storage device 540. In some embodiments, the storage device 540 can, alternatively or in addition, include flash memory, persistent memory, semiconductor (solid state) memory or the like. The computing device 500 can also include a Random Access Memory (RAM) 520 and a Read-Only Memory (ROM) 522. The ROM 522 can store programs, utilities or processes to be executed in a non-volatile manner. The RAM 520 can provide volatile data storage, and stores instructions related to the operation of the computing device 500.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for providing an interactive tutorial user interface (UI) at a computing device, the method comprising:
receiving a selection of a UI element included in a UI displayed at the computing device;
displaying the interactive tutorial UI in response to the selection, wherein the interactive tutorial UI indicates available gestures based on (1) a type of the selection, and (2) a type of the UI element;
identifying a gesture among the available gestures based on a continuous input received in association with the selection; and
hiding the interactive tutorial UI in response to (1) a completion of the gesture, or (2) a cessation of the continuous input.

2. The method of claim 1, wherein the type of the selection is a touch and hold event or a mouse down event.

3. The method of claim 1, wherein the type of the UI element is a header for a column of a spreadsheet, and the available gestures are associated with the following: deleting the column, relocating the column, resizing the column, inserting another column relative to the column, hiding the column, and/or categorizing the column.

4. The method of claim 1, wherein the type of the UI element is a header for a row of a spreadsheet, and the available gestures are associated with the following: deleting the row, relocating the row, resizing the row, inserting another row relative to the row, hiding the row, and/or categorizing the row.

5. The method of claim 1, wherein each gesture of the available gestures is associated with a respective input movement path, and an illustration of the respective input movement path is included in the interactive tutorial UI.

6. The method of claim 5, wherein the interactive tutorial UI includes a customization feature that enables the available gestures to be associated with different respective input movement paths.

7. The method of claim 5, further comprising:
displaying, within the interactive tutorial UI and in correlation to the continuous input, a completion indicator for the respective input movement path of the gesture.

8. The method of claim 7, wherein an image of the UI element and at least one associated UI element is displayed in correlation to the continuous input.

9. The method of claim 1, wherein the interactive tutorial UI is semi-transparent and is displayed locally to where the selection is received.

10. The method of claim 1, wherein, when the interactive tutorial UI is hidden in response to (1) a completion of the gesture, the method further comprises:
performing an operation associated with the gesture.

11. At least one non-transitory computer readable storage medium configured to store instructions that, when executed by at least one processor included in a computing device, cause the computing device to provide an interactive tutorial user interface (UI) at the computing device, by carrying out steps that include:
receiving a selection of a UI element included in a UI displayed at the computing device;
displaying the interactive tutorial UI in response to the selection, wherein the interactive tutorial UI indicates available gestures based on (1) a type of the selection, and (2) a type of the UI element;
identifying a gesture among the available gestures based on a continuous input received in association with the selection; and
hiding the interactive tutorial UI in response to (1) a completion of the gesture, or (2) a cessation of the continuous input.

12. The at least one non-transitory computer readable storage medium of claim 11, wherein each gesture of the available gestures is associated with a respective input movement path, and an illustration of the respective input movement path is included in the interactive tutorial UI.

13. The at least one non-transitory computer readable storage medium of claim 12, wherein the interactive tutorial UI includes a customization feature that enables the available gestures to be associated with different respective input movement paths.

14. The at least one non-transitory computer readable storage medium of claim 12, wherein the steps further include:
displaying, within the interactive tutorial UI and in correlation to the continuous input, a completion indicator for the respective input movement path of the gesture.

15. The at least one non-transitory computer readable storage medium of claim 11, wherein, when the interactive tutorial UI is hidden in response to (1) a completion of the gesture, the steps further include:
performing an operation associated with the gesture.

16. A computing device configured to provide an interactive tutorial user interface (UI), the computing device comprising:
a display device;
at least one memory;
at least one processor communicatively coupled to the display device and to the at least one memory, the at least one processor configured to:
receive a selection of a UI element included in a UI displayed at the computing device;
display the interactive tutorial UI in response to the selection, wherein the interactive tutorial UI indicates available gestures based on (1) a type of the selection, and (2) a type of the UI element;
identify a gesture among the available gestures based on a continuous input received in association with the selection; and
hide the interactive tutorial UI in response to (1) a completion of the gesture, or (2) a cessation of the continuous input.

17. The computing device of claim 16, wherein each gesture of the available gestures is associated with a respective input movement path, and an illustration of the respective input movement path is included in the interactive tutorial UI.

18. The computing device of claim 17, wherein the interactive tutorial UI includes a customization feature that enables the available gestures to be associated with different respective input movement paths.

19. The computing device of claim 17, wherein the at least one processor is configured to:
display, within the interactive tutorial UI and in correlation to the continuous input, a completion indicator for the respective input movement path of the gesture.

20. The computing device of claim 16, wherein, when the interactive tutorial UI is hidden in response to (1) a completion of the gesture, the at least one processor is further configured to:
perform an operation associated with the gesture.
